(19) United States
(12) Patent Application Publication
(10) Pub. No.: US 2025/0277110 A1
(43) Pub. Date: Sep. 4, 2025

(54) FLAME RETARDANT COPOLYESTER COMPOSITIONS

(71) Applicant: Eastman Chemical (China) Co., Ltd., Shanghai (CN)

(72) Inventors: Na Rong An, Shanghai (CN); Robert Erik Young, Kingsport, TN (US)

(73) Assignee: Eastman Chemical (China) Co., Ltd., Shanghai (CN)

(21) Appl. No.: 18/858,859

(22) PCT Filed: Apr. 26, 2022
(86) PCT No.: PCT/CN2022/089278

§ 371 Date: Oct. 22, 2024

(51) Int. Cl. C08L 67/02; C08K 5/3492

(52) U.S. Cl. CPC C08L 67/02; C08K 5/34924; C08L 2201/02; C08L 2205/03; C08L 2205/08

(57) ABSTRACT

The present invention relates to the combination of certain flame retardant additives in a copolyester to improve the flame retardant properties of the copolyester composition while retaining thermal and impact properties, methods of making the copolyester composition and articles made from the copolyester composition. More specifically, the present invention relates to the use of polyphosphonate flame retardant compounds in copolyester compositions to improve the flame retardant properties while providing acceptable other physical properties.

### FIELD OF THE INVENTION

The present invention relates to the use of a combination of certain additives in a copolyester to improve the flame retardant properties of the copolyester composition. More specifically, the present invention relates to the use of a non-halogenated flame retardant in copolyesters to improve the flame retardant properties while retaining sufficient physical properties for molded part applications.

### BACKGROUND OF THE INVENTION

Flame retardant materials are added to some polymers to improve flame resistance, particularly to meet specific fire standards such as UL94 V-2 or better. However, the addition of flame retardant materials in amounts sufficient to meet the fire standards may have a deleterious effect on certain physical properties of the copolyester containing an effective amount of the flame retardant materials. Further the addition of many flame retardant materials will not be able to meet fire standards of UL94 V-O or better regardless of the amount utilized, let alone maintaining the necessary physical properties of the polymer composition.

Copolyesters can be flame retarded in a variety of means but these methods have some drawbacks. Certain halogen compounds such as Dechlorane Plus® (OxyChem®), decabromodiphenyl oxide or decabromodiphenyl ether can be effective flame retardants, but may be objectionable in the marketplace due to potential concerns of bio-accumulation. Other halogen compounds may not have the same objections, but may cause embrittlement when used at sufficient quantities to flame retard copolyesters. Liquid phosphorous compounds such as triphenyl phosphite or triphenyl phosphate can flame retard copolyesters but at effective use levels, they plasticize and soften the copolyester thus reducing heat resistance to distortion. Solid flame retardants in the melamine and phosphorous classes can be used individually as well, but in the past, such additives were not able to meet fire standards of UL94 V-O or better at 1.5 mm or thinner gage. Plastics used in many applications such as electronics applications, housings for handheld and stationary appliances, and housings or shells for handheld and stationary power tools all have flammability requirements specified in various codes or standards. These applications also have durability or physical property requirements in addition to flammability requirements.

There exists a need for improved copolyester compositions comprising effective flame retardants which exhibit good flame resistance and have acceptable physical properties.

### BRIEF SUMMARY OF THE INVENTION

Applicants have unexpectedly discovered an improved copolyester composition comprising an effective amount of certain non-halogenated flame retardants useful for making articles such as films, sheets, molded parts, or profiles which exhibit good flame resistance while maintaining glass transition temperature and otherwise providing acceptable physical properties.

In one aspect, a copolyester composition is provided that comprises:
(a) a copolyester in an amount from about 45 to about 95 weight %, the copolyester comprising:
   (i) a diacid component comprising
      from 70 to 100 mole % residues of terephthalic acid,
      from 0 to 30 mole % residues of a modifying aromatic diacid having from 8 to 12 carbon atoms, and
      from 0 to 10 mole % residues of an aliphatic dicarboxylic acid; and
   (ii) a glycol component comprising
      from 45 to 95 mole % cyclohexanedimethanol (CHDM) residues
      from 5 to 65 mole % 2,2,4,4-tetramethylcyclobutane-1,3-diol (TMCD) residues, and
      from 0 to 10 mole % of a modifying glycol having 2 to 20 carbon atoms;
   wherein the inherent viscosity of the copolyester is from 0.5 to 1.2 dL/g as determined in 60/40 (wt/wt) phenol/tetrachloroethane at a concentration of 0.5 g/100 ml at 25° C.,
   wherein the weight % is based on the weight of the copolyester, and
   wherein the total mole % of the dicarboxylic acid component is 100 mole % and the total mole % of the glycol component is 100 mole %;
(b) a flame retardant additive comprising a polyphosphonate compound, said flame retardant additive present in an amount from about 5 to about 55 weight %;
(c) at least one of the following: a flame retardant synergist comprising a melamine cycanurate, said synergist present in an amount from 10 to 40 wt %, and/or a multifuctional chain extender in an amount from about 0.1 to about 2 wt %; and
(d) from 0 to about 0.5 weight % of a drip suppressant additive;
   wherein the copolyester composition has a UL 94 V-0 rating or better.

In embodiments, the copolyester composition further comprises:
(e) from about 1 to about 10 wt % of an impact modifier component.

In embodiments, the glycol component comprises from 60 to 95 mole % cyclohexanedimethanol residues and from 5 to 40 mole % of 2,2,4,4-tetramethylcyclobutane-1,3-diol residues. In certain embodiments, the glycol component comprises from 70 to 95 mole % cyclohexanedimethanol residues and from 5 to 30, or 10 to 30, or 15 to 30, or 20 to 30, or 15 to 25 mole % of 2,2,4,4-tetramethylcyclobutane-1,3-diol residues. In certain embodiments, the glycol component comprises from 60 to 75 mole % cyclohexanedimethanol residues and from 25 to 40, or 30 to 40 mole % of 2,2,4,4-tetramethylcyclobutane-1,3-diol residues.

In embodiments, the inherent viscosity of the copolyester is from 0.55 to 0.85, or 0.55 to 0.65, or 0.65 to 0.80, or 0.65 to 0.75 dL/g.

In embodiments, the flame retardant additive is present in an amount from 10 to 20 wt %, or 10 to 18 wt %, or 10 to 15 wt % of the copolyester composition.

In embodiments, the flame retardant additive comprises a polyphosphonate containing compound. In embodiments, the polyphosphonate compound is chosen from a polyphosphonate homopolymer, a polyphosphonate copolymer, polyphosphonate oligomers, or combinations thereof. In certain embodiments, the flame retardant additive can be a polyphosphonate homopolymer chosen from Nofia HM1100 or HM9000. In certain embodiments, the flame retardant additive can be a polyphosphonate copolymer, e.g., Nofia AVG-4.

In embodiments, the copolyester composition further comprises a drip suppressant additive in an amount from 0.05 to 0.4 wt %, or 0.05 to 0.25 wt %, or 0.1 to 0.2 wt %. The drip suppressant can comprise a fluoropolymer. The fluoropolymer can include, but is not limited to, polytetrafluoroethylene (PTFE), e.g., Teflon™ polytetrafluoroethylene. In embodiments, the copolyester composition further comprises a flame retardant (FR) synergist component in an amount from 15 to 35 wt %, or 20 to 30 wt %. In embodiments, the FR synergist component comprises an FR synergist chosen from melamine cyanurate, aluminum phosphinate compounds, melamine polyphosphate (MPP), liquid phosphorous compounds (such as PhireGuard RDP and PhireGuard BDP), other organophosphorus compounds (e.g., compounds that contain phosphorus(V) with a double bond between P and N), or combinations thereof. In embodiments, the FR synergist comprises or is a melamine cyanurate.

In embodiments, the copolyester composition further comprises a chain extender. In certain embodiments, the chain extender comprises a multifunctional epoxide chain extender.

In embodiments, the copolyester composition has a notched Izod impact strength of 30, or 40 or 50, or 60, or 70, or 80, or 90, or 100, or 120, or 130, or 140, or 150, or 175, or 200, or 225, or 250, or 275, or 300 Joules/m or greater measured according to ASTM D256.

In another aspect, an article is provided that comprises a copolyester composition according to one or more of the embodiments, or a combination of any of the embodiments, described herein. In embodiments, the article is in the form of a film, sheet, molded part, or profile.

### DETAILED DESCRIPTION

The present invention may be understood more readily by reference to the following detailed description of certain embodiments of the invention and the working examples.

In accordance with the purpose(s) of this invention, certain embodiments of the invention are described in the Summary of the Invention and are further described herein below. Also, other embodiments of the invention are described herein.

The present invention provides a copolyester composition comprising a copolyester and a flame retardant additive in which the copolyester composition exhibits good flame retardancy, articles made therefrom, and methods of making the composition and articles. The present invention involves the use of a certain class of flame retardant additives to improve the flame retardant properties while retaining certain other physical properties. In embodiments, the flame retardant additive comprises a polyphosphonate compound. When the flame retardant is added at the appropriate concentration with a copolyester, a flame retarded composition possesses a Tg which is about 100° C. or greater, while achieving a UL94 V-0 rating or better.

In embodiments, the polyphosphonate compound is chosen from a polyphosphonate homopolymer, a polyphosphonate copolymer, polyphosphonate oligomers, or combinations thereof. In embodiments, the polyphosphonate homopolymer can have one or more of the following properties: a phosphorus content in a range from 5 to 15 wt %, or 8 to 14 wt %, or 10 to 12 wt %; a weight average molecular weight of 10,000 to 150,000 g/mole, measured using a polystyrene standard; and/or a Tg of 90 to 1000, or 95 to 105 C. In embodiments, the polyphosphonate copolymer can have one or more of the following properties: a phosphorus content in a range from 1 to 10 wt %, or 2 to 8 wt %, or 3 to 7 wt %; a weight average molecular weight of 40,000 to 100,000 g/mole, measured using a polystyrene standard; and/or a Tg of 100 to 155 C, or 110 to 145 C, or 120 to 135 C. In embodiments, the polyphosphonate oligomers can have one or more of the following properties: an average weight average molecular weight of 500 to 8,000, or 750 to 7,000, or 1,000 to 6,000 g/mole, measured using a polystyrene standard; and/or an acid number of 25 to 80, or 30 to 75 or 35 to 70 KOH/g.

In embodiments, the polyphosphonate compound is present in an amount from 5 to 55 wt %, based on the total weight of the copolyester composition. In certain embodiments, the copolyester composition comprises the polyphosphonate compound in an amount from 5 to 25, or 5 to 20, or 5 to 15, or 6 to 12 wt %, and an FR synergist component in an amount from 15 to 45, or 15 to 35, or 20 to 30 wt %, based on the total weight of the copolyester composition. In certain embodiments, the copolyester composition comprises the polyphosphonate compound in an amount from greater than 25 to 55, or 30 to 55, or 35 to 55, or 40 to 55, or 45 to 55, or 30 to 50, or 35 to 50, or 40 to 50, or 45 to 50 wt %, and a chain extender component in an amount from 0.1 to 5, or 0.1 to 4, or 0.1 to 3, or 0.1 to 2, or 0.1 to 1, or 0.1 to 0.5 wt %, based on the total weight of the copolyester composition.

In certain embodiments, the polyphosphonate compound can be a commercially available polyphosphonate homopolymer product, such as NOFIA® HM1100, HM9000, HM5000, and/or HM7000 (from FRX Polymers). In certain embodiments, the polyphosphonate compound can be a commercially available polyphosphonate copolymer product, such as NOFIA® C03000, C06000, and/or AVG-4 (from FRX Polymers). In certain embodiments, the polyphosphonate compound can be a commercially available polyphosphonate oligmer product, such as NOFIA® OL1000, OL1001, and/or OL3001 (from FRX Polymers).

In embodiments, the copolyester composition further comprises a small amount of a drip suppressant additive (as discussed herein), but less than 1 wt %, or less than 0.5 wt %, or less than 0.25 wt %, or less than 0.1 wt %, or less than 0.05 wt %, or no flame retardant synergist additive.

In embodiments, the flame retardant synergist additive can comprise melamine cyanurate, aluminum phosphinate compounds, melamine polyphosphate (MPP), liquid phosphorous compounds (such as PhireGuard RDP and PhireGuard BDP), other organophosphorus compounds (e.g., compounds that contain phosphorus(V) with a double bond between P and N), or combinations thereof. In one embodiment, the FR synergist comprises or is a melamine cyanurate.

In other embodiments, the FR synergist additive can comprise an FR synergist chosen from Ammonium Polyphosphate, Melamine Phosphate, Melamine Pyrophosphate, Melamine Polyphosphate, Melamine poly(Zinc Phosphate), Melamine poly(Aluminum Phosphate), DOPO and DOPO derivatives, para-methyl phenyl phosphate, or combinations thereof.

With regard to the component (e) impact modifiers, such compounds are generally elastomeric compounds or polymers which serve to absorb or dissipate the kinetic energy of an impact. A wide range of known materials are useful in component (e). Various kinds of impact modifiers may be used to practice the present invention. Preferred impact modifiers are those that include at least one functional group that is capable of reacting with at least one terminal group of the macrocyclic polyester oligomer. Examples of suitable impact modifiers include, but are not limited to, various known graft copolymers, core shell polymers, and block copolymers. These polymers may include at least one monomer selected from the group consisting of an alkene, an alkadiene, an arene, an acrylate, and an alcohol. (See, for example, EP 1,694,771B1). One example includes core-shell polymers with cores comprised of rubbery polymers and shells comprised of styrene copolymers (See, for example, U.S. Pat. No. 5,321,056, incorporated herein by reference.) Other examples include core-shell and functional polyolefins such as those described in US 2014/0256848 A1, incorporated herein by reference. See also EP 2 139 948 B1.

Examples of impact modifiers that can be used include, but are not limited to, ethylene/propylene terpolymers; functionalized polyolefins, such as those containing methyl acrylate and/or glycidyl methacrylate; styrene-based block copolymeric impact modifiers, and various acrylic core/shell type impact modifiers. Residues of such additives are also contemplated as part of the polyester composition.

Although not exclusive or exhaustive, some examples of commercially available impact modifiers can include: Modiper® 4300 and Modiper® 4400 available from Nippon Oil & Fat Corporation; Kane Ace® M300, available from Kaneka Americas Holding, Inc.; Kane Ace® B564, available from Kaneka Americas Holding, Inc.; Kane Ace® ECO 1000, available from Kaneka Americas Holding, Inc.; and Lotader® 8900, available from Arkema.

The impact modifiers utilized as component (e) above, are generally present in an amount of about 1 to about 10 percent by weight. In other embodiments, they are present in amounts of about 2 to 10 wt %, or 3 to 9 wt %, or 4 to 8 wt %.

In embodiments, the copolyester composition further comprises a compatibilizer that improves the compatibility of the FR additive and/or FR additive synergist with the copolyester composition matrix. In embodiments, the compatibilizer can comprises a silicone resin. In embodiments, the silicone resin is liquid at 25 C.

Copolyesters useful in the present invention comprise residues of an aromatic diacid and residues of two or more glycols.

The term “copolyester,” as used herein, is intended to include “polyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds. The difunctional carboxylic acid can be a dicarboxylic acid and the difunctional hydroxyl compound can be a dihydric alcohol such as, for example, glycols. Furthermore, as used in this application, the interchangeable terms “diacid” or “dicarboxylic acid” include multifunctional acids, such as branching agents. The term “glycol” as used in this application includes, but is not limited to, diols, glycols, and/or multifunctional hydroxyl compounds. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. The term “residue,” as used herein, means any organic structure incorporated into a polymer through a polycondensation and/or an esterification reaction from the corresponding monomer. The term “repeating unit,” as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, or mixtures thereof or residues thereof useful in a reaction process with a diol to make polyester. The term “modifying aromatic diacid” means an aromatic dicarboxylic acid other than terephthalic acid. The term “modifying glycol” means a glycol other than cyclohexanedimethanol (CHDM) or 2,2,4,4-tetramethylcyclobutane-1,3-diol (TMCD).

In one embodiment, terephthalic acid may be used as the starting material. In another embodiment, dimethyl terephthalate may be used as the starting material. In another embodiment, mixtures of terephthalic acid and dimethyl terephthalate may be used as the starting material and/or as an intermediate material.

The copolyesters used in the present invention typically can be prepared from dicarboxylic acids and diols which react in substantially equal proportions and are incorporated into the copolyester polymer as their corresponding residues. The copolyesters of the present invention, therefore, can contain substantially equal molar proportions of acid residues (100 mole %) and diol (and/or multifunctional hydroxyl compounds) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a copolyester containing 30 mole % isophthalic acid, based on the total acid residues, means the copolyester contains 30 mole % isophthalic acid residues out of a total of 100 mole % acid residues. Thus, there are 30 moles of isophthalic acid residues among every 100 moles of acid residues. In another example, a copolyester containing 30 mole % 1,4-cyclohexanedimethanol, based on the total diol residues, means the copolyester contains 30 mole % 1,4-cyclohexanedimethanol residues out of a total of 100 mole % diol residues. Thus, there are 30 moles of 1,4-cyclohexanedimethanol residues among every 100 moles of diol residues.

In embodiments, the copolyesters comprise 70 to 100 mole % of terephthalic acid (TPA). Alternatively, the copolyesters comprise 80 to 100 mole % TPA, or 90 to 100 mole % TPA or 95 to 100 mole % TPA or 100 mole % TPA. For the purposes of this disclosure, the terms “terephthalic acid” and “dimethyl terephthalate” are used interchangeably herein.

In addition to terephthalic acid, the dicarboxylic acid component of the copolyester useful in the invention can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, from 0.01 to 30 mole %, 0.01 to 20 mole %, from 0.01 to 10 mole %, from 0.01 to 5 mole % and from 0.01 to 1 mole. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the copolyesters useful in the invention can be further modified with up to 10 mole %, such as up to 5 mole % or up to 1 mole % of one or more aliphatic dicarboxylic acids containing 2-16 carbon atoms, such as, for example, malonic, succinic, glutaric, adipic, pimelic, suberic, azelaic and dodecanedioic dicarboxylic acids. Certain embodiments can also comprise 0.01 or more mole %, such as 0.1 or more mole %, 1 or more mole %, 5 or more mole %, or 10 or more mole % of one or more modifying aliphatic dicarboxylic acids. Yet another embodiment contains 0 mole % modifying aliphatic dicarboxylic acids. Thus, if present, it is contemplated that the amount of one or more modifying aliphatic dicarboxylic acids can range from any of these preceding endpoint values including, for example, from 0.01 to 10 mole % and from 0.1 to 10 mole %. The total mole % of the dicarboxylic acid component is 100 mole %.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

The copolyesters useful in the copolyesters compositions of the invention can comprise from 0 to 10 mole %, for example, from 0.01 to 5 mole %, from 0.01 to 1 mole %, from 0.05 to 5 mole %, from 0.05 to 1 mole %, or from 0.1 to 0.7 mole %, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. The copolyester(s) useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole % of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

In embodiments, the CHDM can be 1,4-cyclohexanedimethanol. The 1,4-cyclohexanedimethanol may be cis, trans, or a mixture thereof, for example a cis/trans ratio of 60:40 to 40:60. In another embodiment, the trans-1,4-cyclohexanedimethanol can be present in an amount of 60 to 80 mole %. Alternatively, 1,2- and/or 1-3-cyclohexanedimethanol may be used individually or in combination with each other and/or 1,4-cyclohexanedimethanol.

The glycol component of the copolyester portion of the copolyester composition useful in the various embodiments can contain modifying glycols which are not CHDM or TMCD; in one embodiment, the copolyesters useful in the invention may contain less than 15 mole %, or 10 mole % or less, of one or more modifying glycols.

Modifying glycols useful in the copolyesters herein refer to diols other than other than CHDM or TMCD and may contain 2 to 20, or 2 to 16, carbon atoms. Examples of suitable modifying glycols include, but are not limited to, ethylene glycol, 1,2-propanediol, 1,3-propanediol, neopentyl glycol, 1,4-butanediol, 1,5-pentanediol, 1,6-hexanediol, p-xylene glycol, isosorbide or mixtures thereof. In another embodiment, the modifying glycols are 1,3-propanediol and/or 1,4-butanediol.

In embodiments, the copolyester composition comprises at least one polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 5 to 55 mole % of 2,2,4,4-tetramethyl-1,3-cyclobutanediol (TMCD) residues; and
   ii) 45 to 95 mole % of 1,4-cyclohexanedimethanol (CHDM) residues, wherein the total mole % of the dicarboxylic acid component is 100 mole %, the total mole % of the glycol component is 100 mole %; and
wherein the inherent viscosity of the polyester is from 0.5 to 1.2 dL/g as determined in 60/40 (wt/wt) phenol/tetrachloroethane at a concentration of 0.5 g/100 ml at 25° C.; and wherein the polyester has a Tg of from 100 to 200° C.

In embodiments, the polyester composition comprises at least one polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 20 to 40 mole % of 2,2,4,4-tetramethyl-1,3-cyclobutanediol residues; and
   ii) 60 to 80 mole % of 1,4-cyclohexanedimethanol residues,
wherein the total mole % of the dicarboxylic acid component is 100 mole %, the total mole % of the glycol component is 100 mole %; and
wherein the inherent viscosity of the polyester is from 0.35 to 0.85 dL/g as determined in 60/40 (wt/wt) phenol/tetrachloroethane at a concentration of 0.5 g/100 ml at 25° C.; and wherein the polyester has a Tg of from 100 to 120° C.

In embodiments, the polyester composition comprises at least one polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 40 to 55 mole % of 2,2,4,4-tetramethyl-1,3-cyclobutanediol residues; and
   ii) 45 to 60 mole % of 1,4-cyclohexanedimethanol residues,
wherein the total mole % of the dicarboxylic acid component is 100 mole %, the total mole % of the glycol component is 100 mole %; and
wherein the inherent viscosity of the polyester is from 0.35 to 0.85 dL/g as determined in 60/40 (wt/wt) phenol/tetrachloroethane at a concentration of 0.5 g/100 ml at 25° C.; and wherein the polyester has a Tg of from 120 to 140° C.

In embodiments, the polyester composition comprises at least one polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 15 to 70 mole % of 2,2,4,4-tetramethyl-1,3-cyclobutanediol residues; and
   ii) 30 to 85 mole % of 1,4-cyclohexanedimethanol residues,
wherein the total mole % of the dicarboxylic acid component is 100 mole %, the total mole % of the glycol component is 100 mole %; and
wherein the inherent viscosity of the polyester is from 0.35 to 0.85 dL/g as determined in 60/40 (wt/wt) phenol/tetrachloroethane at a concentration of 0.5 g/100 ml at 25° C.; and wherein the polyester has a Tg of from 100 to 140° C.

In embodiments, the polyester composition comprises at least one polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 15 to 90 mole % of 2,2,4,4-tetramethyl-1,3-cyclobutanediol residues; and
   ii) 10 to 85 mole % of 1,4-cyclohexanedimethanol residues,
wherein the total mole % of the dicarboxylic acid component is 100 mole %, the total mole % of the glycol component is 100 mole %; and
wherein the inherent viscosity of the polyester is from 0.1 to 1.2 dL/g as determined in 60/40 (wt/wt) phenol/tetrachloroethane at a concentration of 0.5 g/100 ml at 25° C.; and wherein the polyester has a Tg of from 100 to 200° C.

In embodiments, any one of the polyesters or polyester compositions described herein can further comprise residues of at least one branching agent. In embodiments, any one of the polyesters or polyester compositions described herein can comprise at least one thermal stabilizer or reaction products thereof.

In embodiments, the polyester composition contains at least one polycarbonate. In other embodiments, the polyester composition contains no polycarbonate.

In embodiments, the polyesters can contain less than 15 mole % ethylene glycol residues, such as, for example, 0.01 to less than 15 mole % ethylene glycol residues. In embodiments, the polyesters useful in the invention contain less than 10 mole %, or less than 5 mole %, or less than 4 mole %, or less than 2 mole %, or less than 1 mole % ethylene glycol residues, such as, for example, 0.01 to less than 10 mole %, or 0.01 to less than 5 mole %, or 0.01 to less than 4 mole %, or 0.01 to less than 2 mole %, or 0.01 to less than 1 mole %, ethylene glycol residues. In one embodiment, the polyesters useful in the invention contain no ethylene glycol residues

In other embodiments, the glycol component for the polyesters can include but is not limited to at least one of the following combinations of ranges: 5 to less than 55 mole % 2,2,4,4-tetramethyl-1,3-cyclobutanediol and greater than 45 up to 95 mole % 1,4-cyclohexanedimethanol; 5 to less than 50 mole % 2,2,4,4-tetramethyl-1,3-cyclobutanediol and greater than 50 up to 95 mole % 1,4-cyclohexanedimethanol; 5 to less than 45 mole % 2,2,4,4-tetramethyl-1,3-cyclobutanediol and greater than 55 up to 95 mole % 1,4-cyclohexanedimethanol; 5 to less than 40 mole % 2,2,4,4-tetramethyl-1,3-cyclobutanediol and greater than 60 up to 95 mole % 1,4-cyclohexanedimethanol; 10 to 40 mole % 2,2,4,4-tetramethyl-1,3-cyclobutanediol and 60 to 90 mole % 1,4-cyclohexanedimethanol; 10 to 35 mole % 2,2,4,4-tetramethyl-1,3-cyclobutanediol and 65 to 90 mole % 1,4-cyclohexanedimethanol; 10 to 30 mole % 2,2,4,4-tetramethyl-1,3-cyclobutanediol and 70 to 90 mole % 1,4-cyclohexanedimethanol; 10 to 25 mole % 2,2,4,4-tetramethyl-1,3-cyclobutanediol and 75 to 90 mole % 1,4-cyclohexanedimethanol; 15 to 40 mole % 2,2,4,4-tetramethyl-1,3-cyclobutanediol and 60 to 85 mole % 1,4-cyclohexanedimethanol; 15 to 35 mole % 2,2,4,4-tetramethyl-1,3-cyclobutanediol and 65 to 85 mole % 1,4-cyclohexanedimethanol; 15 to 30 mole % 2,2,4,4-tetramethyl-1,3-cyclobutanediol and 70 to 85 mole % 1,4-cyclohexanedimethanol; 15 to 25 mole % 2,2,4,4-tetramethyl-1,3-cyclobutanediol and 75 to 85 mole % 1,4-cyclohexanedimethanol; 15 to 20 mole % 2,2,4,4-tetramethyl-1,3-cyclobutanediol and 75 to 80 mole % 1,4-cyclohexanedimethanol; and 17 to 23 mole % 2,2,4,4-tetramethyl-1,3-cyclobutanediol and 77 to 83 mole % 1,4-cyclohexanedimethanol.

In certain embodiments, the glycol component of the polyester portion of the polyester composition can contain 25 mole % or less of one or more modifying glycols which are not 2,2,4,4-tetramethyl-1,3-cyclobutanediol or 1,4-cyclohexanedimethanol; in one embodiment, the polyesters useful in the invention may contain less than 15 mole % of one or more modifying glycols. In another embodiment, the polyesters can contain 10 mole % or less of one or more modifying glycols. In another embodiment, the polyesters can contain 5 mole % or less of one or more modifying glycols. In another embodiment, the polyesters can contain 3 mole % or less of one or more modifying glycols. In another embodiment, the polyesters can contain 0 mole % modifying glycols. Certain embodiments can also contain 0.01 or more mole %, such as 0.1 or more mole %, 1 or more mole %, 5 or more mole %, or 10 or more mole % of one or more modifying glycols. Thus, if present, it is contemplated that the amount of one or more modifying glycols can range from any of these preceding endpoint values including, for example, from 0.01 to 15 mole % and from 0.1 to 10 mole %.

In embodiments, modifying glycols in the polyesters can refer to diols other than 2,2,4,4,-tetramethyl-1,3-cyclobutanediol and 1,4-cyclohexanedimethanol and may contain 2 to 16 carbon atoms. Examples of suitable modifying glycols in certain embodiments include, but are not limited to, ethylene glycol, 1,2-propanediol, 1,3-propanediol, neopentyl glycol, 1,4-butanediol, 1,5-pentanediol, 1,6-hexanediol, p-xylene glycol or mixtures thereof. In one embodiment, the modifying glycol is ethylene glycol. In another embodiment, the modifying glycols are 1,3-propanediol and/or 1,4-butanediol. In another embodiment, ethylene glycol is excluded as a modifying diol. In another embodiment, 1,3-propanediol and 1,4-butanediol are excluded as modifying diols. In another embodiment, 2,2-dimethyl-1,3-propanediol is excluded as a modifying diol.

In embodiments, the mole % of cis-2,2,4,4-tetramethyl-1,3-cyclobutanediol in certain polyesters is greater than 50 mole % or greater than 55 mole % of cis-2,2,4,4-tetramethyl-1,3-cyclobutanediol or greater than 70 mole % of cis-2,2,4,4-tetramethyl-1,3-cyclobutanediol; wherein the total mole percentage of cis-2,2,4,4-tetramethyl-1,3-cyclobutanediol and trans-2,2,4,4-tetramethyl-1,3-cyclobutanediol is equal to a total of 100 mole %.

In embodiments, the mole % of the isomers of 2,2,4,4-tetramethyl-1,3-cyclobutanediol in certain polyesters is from 30 to 70 mole % of cis-2,2,4,4-tetramethyl-1,3-cyclobutanediol or from 30 to 70 mole % of trans-2,2,4,4-tetramethyl-1,3-cyclobutanediol, or from 40 to 60 mole % of cis-2,2,4,4-tetramethyl-1,3-cyclobutanediol or from 40 to 60 mole % of trans-2,2,4,4-tetramethyl-1,3-cyclobutanediol, wherein the total mole percentage of cis-2,2,4,4-tetramethyl-1,3-cyclobutanediol and trans-2,2,4,4-tetramethyl-1,3-cyclobutanediol is equal to a total of 100 mole %.

In certain embodiments, the polyesters can be amorphous or semi-crystalline. In one aspect, certain polyesters can have a relatively low crystallinity. Certain polyesters can thus have a substantially amorphous morphology, meaning that the polyesters comprise substantially unordered regions of polymer.

In embodiments, the Tg of the polyesters can be at least one of the following ranges: 100 to 200° C.; 100 to 190° C.; 100 to 180° C.; 100 to 170° C.; 100 to 160° C.; 100 to 155° C.; 100 to 150° C.; 100 to 145° C.; 100 to 140° C.; 100 to 138° C.; 100 to 135° C.; 100 to 130° C.; 100 to 125° C.; 100 to 120° C.; 100 to 115° C.; 100 to 110° C.; 105 to 200° C.; 105 to 190° C.; 105 to 180° C.; 105 to 170° C.; 105 to 160° C.; 105 to 155° C.; 105 to 150° C.; 105 to 145° C.; 105 to 140° C.; 105 to 138° C.; 105 to 135° C.; 105 to 130° C.; 105 to 125° C.; 105 to 120° C.; 105 to 115° C.; 105 to 110° C. greater than 105 to 125° C.; greater than 105 to 120° C.; greater than 105 to 115° C.; greater than 105 to 110° C.; 110 to 200° C.; 110 to 190° C.; 110 to 180° C.; 110 to 170° C.; 110 to 160° C.; 110 to 155° C.; 110 to 150° C.; 110 to 145° C.; 110 to 140° C.; 110 to 138° C.; 110 to 135° C.; 110 to 130° C.; 110 to 125° C.; 110 to 120° C.; 110 to 115° C.; 115 to 200° C.; 115 to 190° C.; 115 to 180° C.; 115 to 170° C.; 115 to 160° C.; 115 to 155° C.; 115 to 150° C.; 115 to 145° C.; 115 to 140° C.; 115 to 138° C.; 115 to 135° C.; 110 to 130° C.; 115 to 125° C.; 115 to 120° C.; 120 to 200° C.; 120 to 190° C.; 120 to 180° C.; 120 to 170° C.; 120 to 160° C.; 120 to 155° C.; 120 to 150° C.; 120 to 145° C.; 120 to 140° C.; 120 to 138° C.; 120 to 135° C.; 120 to 130° C.; 125 to 200° C.; 125 to 190° C.; 125 to 180° C.; 125 to 170° C.; 125 to 160° C.; 125 to 155° C.; 125 to 150° C.; 125 to 145° C.; 125 to 140° C.; 125 to 138° C.; 125 to 135° C.; 127 to 200° C.; 127 to 190° C.; 127 to 180° C.; 127 to 170° C.; 127 to 160° C.; 127 to 150° C.; 127 to 145° C.; 127 to 140° C.; 127 to 138° C.; 127 to 135° C.; 130 to 200° C.; 130 to 190° C.; 130 to 180° C.; 130 to 170° C.; 130 to 160° C.; 130 to 155° C.; 130 to 150° C.; 130 to 145° C.; 130 to 140° C.; 130 to 138° C.; 130 to 135° C.; 135 to 200° C.; 135 to 190° C.; 135 to 180° C.; 135 to 170° C.; 135 to 160° C.; 135 to 155° C.; 135 to 150° C.; 135 to 145° C.; 135 to 140° C.; 140 to 200° C.; 140 to 190° C.; 140 to 180° C.; 140 to 170° C.; 140 to 160° C.; 140 to 155° C.; 140 to 150° C.; 140 to 145° C.; 148 to 200° C.; 148 to 190° C.; 148 to 180° C.; 148 to 170° C.; 148 to 160° C.; 148 to 155° C.; 148 to 150° C.; 150 to 200° C.; 150 to 190° C.; 150 to 180° C.; 150 to 170° C.; 150 to 160; 155 to 190° C.; 155 to 180° C.; 155 to 170° C.; and 155 to 165° C.

The glass transition temperature (Tg) of the polyesters can be determined using a TA DSC 2920 from Thermal Analyst Instrument at a scan rate of 20° C./min.

For certain embodiments, the polyesters may exhibit at least one of the following inherent viscosities as determined in 60/40 (wt/wt) phenol/tetrachloroethane at a concentration of 0.5 g/100 ml at 25° C.: 0.10 to 1.2 dL/g; 0.10 to 1.1 dL/g; 0.10 to 1 dL/g; 0.10 to less than 1 dL/g; 0.10 to 0.98 dL/g; 0.10 to 0.95 dL/g; 0.10 to 0.90 dL/g; 0.10 to 0.85 dL/g; 0.10 to 0.80 dL/g; 0.10 to 0.75 dL/g; 0.10 to less than 0.75 dL/g; 0.10 to 0.72 dL/g; 0.10 to 0.70 dL/g; 0.10 to less than 0.70 dL/g; 0.10 to 0.68 dL/g; 0.10 to less than 0.68 dL/g; 0.10 to 0.65 dL/g; 0.20 to 1.2 dL/g; 0.20 to 1.1 dL/g; 0.20 to 1 dL/g; 0.20 to less than 1 dL/g; 0.20 to 0.98 dL/g; 0.20 to 0.95 dL/g; 0.20 to 0.90 dL/g; 0.20 to 0.85 dL/g; 0.20 to 0.80 dL/g; 0.20 to 0.75 dL/g; 0.20 to less than 0.75 dL/g; 0.20 to 0.72 dL/g; 0.20 to 0.70 dL/g; 0.20 to less than 0.70 dL/g; 0.20 to 0.68 dL/g; 0.20 to less than 0.68 dL/g; 0.20 to 0.65 dL/g; 0.35 to 1.2 dL/g; 0.35 to 1.1 dL/g; 0.35 to 1 dL/g; 0.35 to less than 1 dL/g; 0.35 to 0.98 dL/g; 0.35 to 0.95 dL/g; 0.35 to 0.90 dL/g; 0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g; 0.35 to less than 0.70 dL/g; 0.35 to 0.68 dL/g; 0.35 to less than 0.68 dL/g; 0.35 to 0.65 dL/g; 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.40 to less than 0.70 dL/g; 0.40 to 0.68 dL/g; 0.40 to less than 0.68 dL/g; 0.40 to 0.65 dL/g; greater than 0.42 to 1.2 dL/g; greater than 0.42 to 1.1 dL/g; greater than 0.42 to 1 dL/g; greater than 0.42 to less than 1 dL/g; greater than 0.42 to 0.98 dL/g; greater than 0.42 to 0.95 dL/g; greater than 0.42 to 0.90 dL/g; greater than 0.42 to 0.85 dL/g; greater than 0.42 to 0.80 dL/g; greater than 0.42 to 0.75 dL/g; greater than 0.42 to less than 0.75 dL/g; greater than 0.42 to 0.72 dL/g; greater than 0.42 to less than 0.70 dL/g; greater than 0.42 to 0.68 dL/g; greater than 0.42 to less than 0.68 dL/g; and greater than 0.42 to 0.65 dL/g.

For certain embodiments, the polyesters may exhibit at least one of the following inherent viscosities as determined in 60/40 (wt/wt) phenol/tetrachloroethane at a concentration of 0.5 g/100 ml at 25° C.: 0.45 to 1.2 dL/g; 0.45 to 1.1 dL/g; 0.45 to 1 dL/g; 0.45 to 0.98 dL/g; 0.45 to 0.95 dL/g; 0.45 to 0.90 dL/g; 0.45 to 0.85 dL/g; 0.45 to 0.80 dL/g; 0.45 to 0.75 dL/g; 0.45 to less than 0.75 dL/g; 0.45 to 0.72 dL/g; 0.45 to 0.70 dL/g; 0.45 to less than 0.70 dL/g; 0.45 to 0.68 dL/g; 0.45 to less than 0.68 dL/g; 0.45 to 0.65 dL/g; 0.50 to 1.2 dL/g; 0.50 to 1.1 dL/g; 0.50 to 1 dL/g; 0.50 to less than 1 dL/g; 0.50 to 0.98 dL/g; 0.50 to 0.95 dL/g; 0.50 to 0.90 dL/g; 0.50 to 0.85 dL/g; 0.50 to 0.80 dL/g; 0.50 to 0.75 dL/g; 0.50 to less than 0.75 dL/g; 0.50 to 0.72 dL/g; 0.50 to 0.70 dL/g; 0.50 to less than 0.70 dL/g; 0.50 to 0.68 dL/g; 0.50 to less than 0.68 dL/g; 0.50 to 0.65 dL/g; 0.55 to 1.2 dL/g; 0.55 to 1.1 dL/g; 0.55 to 1 dL/g; 0.55 to less than 1 dL/g; 0.55 to 0.98 dL/g; 0.55 to 0.95 dL/g; 0.55 to 0.90 dL/g; 0.55 to 0.85 dL/g; 0.55 to 0.80 dL/g; 0.55 to 0.75 dL/g; 0.55 to less than 0.75 dL/g; 0.55 to 0.72 dL/g; 0.55 to 0.70 dL/g; 0.55 to less than 0.70 dL/g; 0.55 to 0.68 dL/g; 0.55 to less than 0.68 dL/g; 0.55 to 0.65 dL/g; 0.58 to 1.2 dL/g; 0.58 to 1.1 dL/g; 0.58 to 1 dL/g; 0.58 to less than 1 dL/g; 0.58 to 0.98 dL/g; 0.58 to 0.95 dL/g; 0.58 to 0.90 dL/g; 0.58 to 0.85 dL/g; 0.58 to 0.80 dL/g; 0.58 to 0.75 dL/g; 0.58 to less than 0.75 dL/g; 0.58 to 0.72 dL/g; 0.58 to 0.70 dL/g; 0.58 to less than 0.70 dL/g; 0.58 to 0.68 dL/g; 0.58 to less than 0.68 dL/g; 0.58 to 0.65 dL/g; 0.60 to 1.2 dL/g; 0.60 to 1.1 dL/g; 0.60 to 1 dL/g; 0.60 to less than 1 dL/g; 0.60 to 0.98 dL/g; 0.60 to 0.95 dL/g; 0.60 to 0.90 dL/g; 0.60 to 0.85 dL/g; 0.60 to 0.80 dL/g; 0.60 to 0.75 dL/g; 0.60 to less than 0.75 dL/g; 0.60 to 0.72 dL/g; 0.60 to 0.70 dL/g; 0.60 to less than 0.70 dL/g; 0.60 to 0.68 dL/g; 0.60 to less than 0.68 dL/g; 0.60 to 0.65 dL/g; 0.65 to 1.2 dL/g; 0.65 to 1.1 dL/g; 0.65 to 1 dL/g; 0.65 to less than 1 dL/g; 0.65 to 0.98 dL/g; 0.65 to 0.95 dL/g; 0.65 to 0.90 dL/g; 0.65 to 0.85 dL/g; 0.65 to 0.80 dL/g; 0.65 to 0.75 dL/g; 0.65 to less than 0.75 dL/g; 0.65 to 0.72 dL/g; 0.65 to 0.70 dL/g; 0.65 to less than 0.70 dL/g; 0.68 to 1.2 dL/g; 0.68 to 1.1 dL/g; 0.68 to 1 dL/g; 0.68 to less than 1 dL/g; 0.68 to 0.98 dL/g; 0.68 to 0.95 dL/g; 0.68 to 0.90 dL/g; 0.68 to 0.85 dL/g; 0.68 to 0.80 dL/g; 0.68 to 0.75 dL/g; 0.68 to less than 0.75 dL/g; 0.68 to 0.72 dL/g; greater than 0.76 dug to 1.2 dL/g; greater than 0.76 dL/g to 1.1 dL/g; greater than 0.76 dL/g to 1 dL/g; greater than 0.76 dL/g to less than 1 dL/g; greater than 0.76 dL/g to 0.98 dL/g; greater than 0.76 dL/g to 0.95 dL/g; greater than 0.76 dL/g to 0.90 dL/g; greater than 0.80 dL/g to 1.2 dL/g; greater than 0.80 dL/g to 1.1 dL/g; greater than 0.80 dL/g to 1 dL/g; greater than 0.80 dL/g to less than 1 dL/g; greater than 0.80 dL/g to 1.2 dL/g; greater than 0.80 dL/g to 0.98 dL/g; greater than 0.80 dL/g to 0.95 dL/g; greater than 0.80 dL/g to 0.90 dL/g.

In certain embodiments, it is contemplated that the polyester compositions can possess at least one of the inherent viscosity ranges described herein and at least one of the monomer ranges for the compositions described herein unless otherwise stated. It is also contemplated that the polyester compositions can possess at least one of the Tg ranges described herein and at least one of the monomer ranges for the compositions described herein unless otherwise stated. It is also contemplated that the polyester compositions can possess at least one of the Tg ranges described herein, at least one of the inherent viscosity ranges described herein, and at least one of the monomer ranges for the compositions described herein unless otherwise stated.

In embodiments, the molar ratio of cis/trans 2,2,4,4-tetramethyl-1,3-cyclobutanediol can vary from the pure form of each or mixtures thereof. In certain embodiments, the molar percentages for cis and/or trans 2,2,4,4,-tetramethyl-1,3-cyclobutanediol are greater than 50 mole % cis and less than 50 mole % trans; or greater than 55 mole % cis and less than 45 mole % trans; or 30 to 70 mole % cis and 70 to 30% trans; or 40 to 60 mole % cis and 60 to 40 mole % trans; or 50 to 70 mole % trans and 50 to 30% cis or 50 to 70 mole % cis and 50 to 30% trans; or 60 to 70 mole % cis and 30 to 40 mole % trans; or greater than 70 mole cis and less than 30 mole % trans; wherein the total sum of the mole percentages for cis- and trans-2,2,4,4-tetramethyl-1,3-cyclobutanediol is equal to 100 mole %. The molar ratio of cis/trans 1,4-cyclohexandimethanol can vary within the range of 50/50 to 0/100, such as between 40/60 to 20/80.

The polyester portion of the polyester compositions can be made by processes known from the literature such as, for example, by processes in homogenous solution, by transesterification processes in the melt, and by two phase interfacial processes. Suitable methods include those disclosed in U.S. Published Application 2006/0287484, the contents of which is incorporated herein by reference.

In embodiments, the polyester can be prepared by a method that includes reacting one or more dicarboxylic acids (or derivative thereof) with one or more glycols under conditions to provide the polyester including, but are not limited to, the steps of reacting one or more dicarboxylic acids (or derivative thereof) with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

In embodiments, the polyester composition can be a polymer blend, wherein the blend comprises: (a) 5 to 95 wt % of at least one of the polyesters described herein; and (b) 5 to 95 wt % of at least one polymeric component. Although not exclusive or exhaustive, some examples of potential polymeric components include, but are not limited to, nylon, polyesters different from those described herein, e.g., polyethylene or polybutylene terephthalate (PET or PBT), polyamides such as ZYTEL® from DuPont; polystyrene, polystyrene copolymers, styrene acrylonitrile copolymers, acrylonitrile butadiene styrene copolymers, poly(methylmethacrylate), acrylic copolymers, poly(ether-imides) such as ULTEM® (a poly(ether-imide) from General Electric); polyphenylene oxides such as poly(2,6-dimethylphenylene oxide) or poly(phenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(ester-carbonates); polycarbonates such as LEXAN® (a polycarbonate from General Electric); polysulfones; polysulfone ethers; and poly(ether-ketones) of aromatic dihydroxy compounds; or mixtures of any of the other foregoing polymers. The blends can be prepared by conventional processing techniques known in the art, such as melt blending or solution blending. In one embodiment, the polycarbonate is not present in the polyester composition. However, the polyester compositions useful in the invention also contemplate the exclusion of polycarbonate as well as the inclusion of polycarbonate.

In addition, the copolyester composition may further comprise one or more additional additives chosen from colorants, dyes, mold release agents, additional flame retardants, plasticizers, processing aids, rheology modifiers, nucleating agents, antioxidants, light stabilizers, fillers, and reinforcing materials.

In embodiments, the polyester compositions and the polymer blend compositions may also contain from 0.01 to 25% by weight of the overall composition common additives such as colorants, dyes, mold release agents, additional flame retardants, plasticizers, nucleating agents, stabilizers, including but not limited to, UV stabilizers, thermal stabilizers and/or reaction products thereof, fillers, and impact modifiers. For example, UV additives can be incorporated into the articles (e.g., ophthalmic product(s)) through addition to the bulk or in the hard coat. Examples of typical commercially available impact modifiers well known in the art and useful in this invention include, but are not limited to, ethylene/propylene terpolymers; functionalized polyolefins, such as those containing methyl acrylate and/or glycidyl methacrylate; styrene-based block copolymeric impact modifiers, epoxide-functionalized impact modifiers, and various acrylic core/shell type impact modifiers. Residues of such additives are also contemplated as part of the polyester composition. In one embodiment, the composition comprises an epoxide-functionalized impact modifier.

In one aspect, the copolyester compositions of the present invention comprise a copolyester composition comprising any of the copolyesters described above and the polyphosphonate compound flame retardant.

In embodiments, the polyesters can comprise at least one chain extender additive. Suitable chain extender additives can include, but are not limited to, multifunctional (including, but not limited to, bifunctional) isocyanates, multifunctional epoxides, including for example, epoxylated novolacs, and phenoxy resins. Examples of other chain extender additives can include thioethers, carbodiimides, glycol dimers and mellitic anhydrides. In embodiments, the chain extender additives have epoxide pendent groups. In one embodiment, the chain extender additive can be one or more styrene-acrylate copolymers with epoxide functionalities. In one embodiment, the chain extending additive can be one or more copolymers of glycidyl methacrylate with styrene. In embodiments, the chain extender additive can be chosen from a glycidyl methacrylate modified epoxide, a styrene and glycidyl methacrylate random copolymer, or a combination thereof. In embodiments, the chain extender additive can be a glycidyl methacrylate modified epoxide having a weight average molecular weight (Mw) in a range from 5,000 to 10,000, or 6,000 to 8,000 g/mole, measured using a polystyrene standard. In embodiments, the chain extender additive can be a styrene and glycidyl methacrylate random copolymer having a weight average molecular weight (Mw) in a range from 40,000 to 60,000, or 45,000 to 55,000 g/mole, measured using a polystyrene standard.

In embodiments, the chain extender additive can include a polymeric additive having multiple pendant epoxy (or epoxide) groups per molecule. For purposes of this application pendent epoxy and epoxide groups can be used interchangeably. In one embodiment, the polymeric chain extender additive can have an average of greater than or equal to 2 pendant epoxy groups per molecule, greater than or equal to 3 pendant epoxy groups per molecule; or an average of greater than or equal to 4 pendant epoxy groups per molecule; or an average of greater than or equal to 5 pendant epoxy groups per molecule; or an average of greater than or equal to 6 pendant epoxy groups per molecule; or an average of greater than or equal to 7 pendant epoxy groups per molecule; or more specifically, an average of greater than or equal to 8 pendant epoxy groups per molecule, or, more specifically, an average of greater than or equal to 11 pendant epoxy groups per molecule, or, more specifically, an average of greater than or equal to 15 pendant epoxy groups per molecule, or, more specifically, an average of greater than or equal to 17 pendant epoxy groups per molecule. The lower limits of the number of pendant epoxy groups may be determined by one of ordinary skill in the art to apply to specific manufacturing conditions and/or to particular end-use applications. In certain embodiments, the chain extender additive can have from 2 to 20 pendant epoxy groups per molecule, or from 5 to 20 pendant epoxy groups per molecule, or from 2 to 15 pendant epoxy groups per molecule, or from 2 to 10 pendant epoxy groups per molecule, or from 2 to 8 pendant epoxy groups per molecule, or 3 to 20 pendant epoxy groups per molecule, or from 3 to 15 pendant epoxy groups per molecule, or from 5 to 15 pendant epoxy groups per molecule, or from 3 to 10 pendant epoxy groups per molecule, or from 5 to 10 pendant epoxy groups per molecule, or from 3 to 8 pendant groups per molecule, or from 3 to 7 pendant epoxy groups per molecule.

In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomers used in the composition and the physical properties desired but is generally from 0.1 percent by weight to 10 percent by weight, such as from 0.1 to 5 percent by weight, based on the total weigh of the polyester. In embodiments, the chain extender is present in an amount from 0.1 to 5, or 0.1 to 4, or 0.1 to 3, or 0.1 to 2, or 0.1 to 1, or 0.1 to 0.75, or 0.1 to 0.5, in weight percent based on the total weight of the polyester composition.

In certain embodiments, the polyester composition (or the polyester contained in the polyester composition) can contain thermal stabilizers. In embodiments, the thermal stabilizers are compounds that can stabilize polyesters during polyester manufacture and/or post polymerization, including, but not limited to, phosphorous compounds, including, but not limited to, phosphoric acid, phosphorous acid, phosphonic acid, phosphinic acid, phosphonous acid, and various esters and salts thereof. The esters can be alkyl, branched alkyl, substituted alkyl, difunctional alkyl, alkyl ethers, aryl, and substituted aryl. In one embodiment, the number of ester groups present in the particular phosphorous compound can vary from zero up to the maximum allowable based on the number of hydroxyl groups present on the thermal stabilizer used. The term “thermal stabilizer” is intended to include the reaction product(s) thereof. The term “reaction product” as used in connection with the thermal stabilizers of the invention refers to any product of a polycondensation or esterification reaction between the thermal stabilizer and any of the monomers used in making the polyester as well as the product of a polycondensation or esterification reaction between the catalyst and any other type of additive. In embodiments, these can be present in the polyester compositions.

In embodiments, reinforcing materials may be useful in the polyester compositions. The reinforcing materials may include, but are not limited to, carbon filaments, silicates, mica, clay, talc, titanium dioxide, Wollastonite, glass flakes, glass beads and fibers, cellulosic fibers and polymeric fibers and combinations thereof. In one embodiment, the reinforcing materials are glass, such as, fibrous glass filaments, mixtures of glass and talc, glass and mica, and glass and polymeric fibers.

In another aspect, the invention relates to copolyester compositions comprising a copolyester produced by a process comprising:
(I) heating a mixture comprising the monomers useful in any of the copolyesters in the invention in the presence of a catalyst at a temperature of 150 to 240° C. for a time sufficient to produce an initial copolyester;
(II) heating the initial copolyester of step (I) at a temperature of 240 to 320° C. for 1 to 4 hours; and
(III) removing any unreacted glycols.

Suitable catalysts for use in this process include, but are not limited to, organo-zinc or tin compounds. The use of this type of catalyst is well known in the art. Examples of catalysts useful in the present invention include, but are not limited to, zinc acetate, butyltin tris-2-ethylhexanoate, dibutyltin diacetate, and dibutyltin oxide. Other catalysts may include, but are not limited to, those based on titanium, zinc, manganese, lithium, germanium, and cobalt. Catalyst amounts can range from 10 ppm to 20,000 ppm or 10 to 10,000 ppm, or 10 to 5000 ppm or 10 to 1000 ppm or 10 to 500 ppm, or 10 to 300 ppm or 10 to 250 based on the catalyst metal and based on the weight of the final polymer. The process can be carried out in either a batch or continuous process.

Typically, step (I) can be carried out until 50% by weight or more of the glycol has been reacted. Step (I) may be carried out under pressure, ranging from atmospheric pressure to 100 psig. The term “reaction product” as used in connection with any of the catalysts useful in the invention refers to any product of a polycondensation or esterification reaction with the catalyst and any of the monomers used in making the polyester as well as the product of a polycondensation or esterification reaction between the catalyst and any other type of additive.

Typically, step (II) and step (III) can be conducted at the same time. These steps can be carried out by methods known in the art such as by placing the reaction mixture under a pressure ranging from 0.002 psig to below atmospheric pressure, or by blowing hot nitrogen gas over the mixture.

In one embodiment, a copolyester composition is provided that comprises the copolyester and a polyphosphonate compound flame retardant, wherein the composition comprises 5 to 20 weight % of the flame retardant and 10 to 40 weight % of the synergist, based on the total weight of the composition. In one embodiment, the flame retardant consists essentially of a polyphosphonate homopolymer.

In another embodiment, a copolyester composition is provided that comprises the copolyester and a polyphosphonate compound flame retardant, wherein the composition comprises greater than 25 to 55 weight % of the flame retardant and 0.1 to 2 weight % of the chain extender additive, based on the total weight of the composition. In one embodiment, the flame retardant consists essentially of a polyphosphonate homopolymer. In one embodiment, the flame retardant consists essentially of a polyphosphonate copolymer, e.g., a polyphosphonate-co-carbonate.

The flame retardant can be incorporated into the copolyester by any conventional method for ultimate formation into an article.

The flame retardant can be incorporated in a plastics compounding line such as a twin-screw compounding line to form a copolyester composition concentrate. In embodiments, the copolyester pellets are dried for 4 to 6 hours at 150° F. to 190° F. (65.6° C. to 87.8° C.) to reduce moisture. The pellets can be fed into the throat of an extruder and melted from 400° F. to 570° F. (204° C. to 300° C.) to produce a viscous thermoplastic material. Alternatively, the flame retardant can be pre-blended and added as a single powder with a loss-in-weight feeder or added singly in a loss-in-weight feeder. The rotation of the two screws can disperse the flame retardant into the copolyester. The mixture can be extruded through a die to produce multiple strands. In certain embodiments, the strands can be fed through a water trough to cool the pellets. Upon exiting the water trough, the strands can be dried and fed into a dicer to cut the strands into pellets. Alternatively, the mixture can be extruded through a circular flat plate die with multiple openings into water. The flat plate die has a rotating cutter that slices the strands as they extrude from the die to produce pellets. The continuous flow of water cools the pellets and transports them to a drying section, typically a centrifuge to separate the pellets from the water.

Alternatively, the flame retardants can be incorporated into a plastics compounding line such as a two-rotor continuous compounding mixer (such as a Farrell Continuous Mixer) to form a copolyester composition. In embodiments, the copolyester pellets can be dried for 4 to 6 hours at 150° F. to 190° F. (65.6° C. to 87.8° C.) to reduce moisture. The copolyester pellets and the flame retardant can be fed into the throat of the continuous mixer and melted into a homogenous mixture at 430° F. to 520° F. (221° C. to 271° C.). The output rate of the mixer is controlled by varying the area of a discharge orifice. The melt can be sliced off into ‘loaves’ and fed to a two-roll mill or the throat of a single screw extruder. In the case of the melt being fed to a two-roll mill, the melt covers one of the rolls to form a sheet of the concentrate which is cut into strips which are fed to the throat of a single screw extruder. The mixture is then extruded through a die to produce multiple strands. The strands can be fed through a water trough to cool the pellets. Upon exiting the water trough, the strands are dried and fed into a dicer to cut the strands into pellets. Alternatively, the mixture can be extruded through a circular flat plate die with multiple openings into water. The flat plate die has a rotating cutter that slices the strands as they extrude from the die to produce pellets. The continuous flow of water cools the pellets and transports them to a drying section, typically a centrifuge to separate the pellets from the water. In the case of the ‘loaves’ being fed to a single screw extruder, the mixture can be extruded through a die to produce multiple strands. The strands can be fed through a water trough to cool the pellets. Upon exiting the water trough, the strands are dried and fed into a dicer to cut the strands into pellets. Alternatively, the mixture can be extruded through a circular flat plate die with multiple openings into water. The flat plate die has a rotating cutter that slices the strands as they extrude from the die to produce pellets. The continuous flow of water cools the pellets and transports them to a drying section, typically a centrifuge to separate the pellets from the water.

Alternatively, the flame retardant can be incorporated in a high-intensity mixer such a Banbury® batch type mixer to form a copolyester composition. In embodiments, the copolyester pellets can be dried for 4 to 6 hours at 150° F. to 190° F. (65.6° C. to 87.8° C.) to reduce moisture. The copolyester pellets and the flame retardants are charged into a high-intensity mixer and a ram lowered to compress the pellet/flame retardants mixture into the mixing chamber. Two rotating mixer blades melt the pellets and disperse the flame retardant into the melt. When the desired temperature is reached, a door is opened in the bottom of the mixer and the mixture is dropped onto a two-roll mill. A ribbon from the two-roll mill can then be fed to a single screw extruder. The mixture is then extruded through a die to produce multiple strands. The strands can be fed through a water trough to cool the pellets. Upon exiting the water trough, the strands are dried and fed into a dicer to cut the strands into pellets. Alternatively, the mixture can be extruded through a circular flat plate die with multiple openings into water. The flat plate die has a rotating cutter that slices the strands as they extrude from the die to produce pellets. The continuous flow of water cools the pellets and transports them to a drying section, typically a centrifuge to separate the pellets from the water.

The present invention includes plastic articles comprising the copolyester compositions. The plastic articles may be made by processes comprising, but not limited to, extrusion of the copolyester composition to produce a continuous flat sheet or profile or injection molding to create discrete articles or calendering to produce a continuous film or sheet or additive manufacturing of a powder or filament to produce a three-dimensional shape.

Films and/or sheets useful in the present invention can be of any thickness which would be apparent to one of ordinary skill in the art. In one embodiment, the films(s) of the invention have a thickness of less than 30 mils or less than 20 mils or less than 10 mils or less than 5 mils. In one embodiment, the sheets of the invention have a thickness of greater than 30 mils. In one embodiment, the sheets of the invention have a thickness of from 30 mils to 100 mils or from 30 mils to 200 mils or from 30 mils to 500 mils.

The invention further relates to the films and/or sheets comprising the polyester compositions of the invention. The methods of forming the polyesters into films and/or sheets are well known in the art. Examples of films and/or sheets of the invention include, but are not limited to, extruded films and/or sheets, calendered films and/or sheets, compression molded films and/or sheets, injection molded films or sheets, and solution casted films and/or sheets. Methods of making film and/or sheet include but are not limited to extrusion, calendering, extrusion molding, compression molding, and solution casting. These films or sheets may be made or subjected to further processing such as orientation (uniaxial or biaxial), heat setting, surface treatment, etc.

In one embodiment of the invention comprises a flat sheet or profile. The sheet or profile is prepared by extruding the copolyester composition to produce a flat sheet or profile. In this case, pellets of the copolyester composition are dried at 150° F. to 190° F. (65.6° C. to 87.8° C.) for 4 to 6 hours and are then fed to either a single screw extruder, a twin-screw extruder, or a conical twin screw extruder. The copolyester composition pellets are conveyed and compressed by the screw(s) down the extruder barrel to melt the pellets and discharge the melt from the end of the extruder. The melt is fed through a screening device to remove debris and/or a melt pump to reduce pressure variations caused by the extruder. The melt is then fed through a die to create a continuous flat sheet or into a profile die to create a continuous shape. In one embodiment of the invention comprising a flat sheet die, the melt is extruded onto a series of metal rolls, typically three, to cool the melt and impart a finish onto the sheet. The flat sheet is then conveyed in a continuous sheet for a distance or period of time sufficient to cool the sheet. The sheet is then trimmed to the desired width and then either rolled up into a roll or sheared or sawed into sheet form of desired dimensions. A flat sheet can also be formed into a shaped article through mechanical means to form a desired shaped article and then cooled either by spraying with water, by conveying through a water trough or by blowing air on the shaped article. The article then sawed or sheared to the desired length. In the case of a profile die, the die is designed to produce the desired shape of the profile. After exiting the die, the profile is then cooled either by spraying with water, by conveying through a water trough or by blowing air on the profile. The profile is then sawed or sheared to the desired length. In the case of a fiber, the fiber can be pulled out of the extrusion die spinnerets to the desired fiber diameter and crystallized for physical property enhancement.

In embodiments, the copolyester composition can be prepared by a process that comprises mixing neat copolyester pellets with a flame retardant and then extruding the copolyester composition. The flame retardant containing composition can be compounded as a pellet. In embodiments, the pellets can be dried at 150° F. to 190° F. (65.6° C. to 87.8° C.) for 4 to 6 hours before extrusion. The pellets can be dried after being blended in a low-intensity mixer such as a ribbon blender, a tumbler, or conical screw blender. The pellets can be fed to an extruder including, but not limited to, a single screw extruder, a twin-screw extruder, or a conical twin screw extruder. The pellets are conveyed and compressed by the screw(s) down the extruder barrel to melt the pellets and discharge the melt from the end of the extruder. The melt is typically fed through a screening device to remove debris and/or a melt pump to reduce pressure variations caused by the extruder. The melt is then fed through a die to create a continuous flat sheet or into a profile die to create a continuous shape. In the case of the flat sheet die, the melt is extruded onto a series of metal rolls, typically three, to cool the melt and impart a finish onto the sheet. The flat sheet is then conveyed in a continuous sheet for a distance or period of time sufficient to cool the sheet. It can then be trimmed to the desired width and then either rolled up into a roll or sheared or sawed into sheet form. A flat sheet can also be formed into a shape through mechanical means to form a desired shape and then cooled either by spraying with water, through a water trough or by blowing air on the shaped article. It can then be sawed or sheared to the desired length. In the case of a film, the film may be produced and wound into a roll. In the case of a profile die, the die is designed to produce the desired shape of the article. After exiting the die, the profile can then be cooled either by spraying with water, through a water trough or by blowing air on the profile. It can then be sawed or sheared to the desired length. In the case of a fiber, the fiber can be pulled out of the extrusion die spinnerets to the desired fiber diameter and crystallized for physical property enhancement.

In embodiments, the copolyester composition can comprise mixing neat copolyester pellets with a flame retardant and then extruding them with either short or long strand glass fiber reinforcement or extruding them into a continuous glass fiber composite film, sheet or tape. The flame retardant containing composition can be compounded as a single pellet. In embodiments, the pellets can be dried at 150° F. to 190° F. (65.6° C. to 87.8° C.) for 4 to 6 hours before extrusions. The pellets can be dried separately or together after being blended in a low-intensity mixer such as a ribbon blender, a tumbler, or conical screw blender. The pellets are then fed to either a single screw extruder, a twin-screw extruder, or a conical twin screw extruder. The pellets are conveyed and compressed by the screw(s) down the extruder barrel to melt the pellets and discharge the melt from the end of the extruder. The melt can be fed through a screening device to remove debris and/or a melt pump to reduce pressure variations caused by the extruder. The melt can then be fed through a die to create a continuous flat sheet or into a profile die to create a continuous shape. In the case of the flat sheet die, the melt is extruded onto a series of metal rolls, typically three, to cool the melt and impart a finish onto the sheet. The flat sheet is then conveyed in a continuous sheet to cool the sheet. It can then be trimmed to the desired width and then either rolled up into a roll or sheared or sawed into sheet form. A flat sheet can also be formed into a shape through mechanical means to form a desired shape and then cooled either by spraying with water, through a water trough or by blowing air on the profile. It can then be sawed or sheared to the desired length or a film may be produced and wound into a roll. In the case of a profile die, the die is designed to produce the desired shape of the article. After exiting the die, it can then be cooled either by spraying with water, through a water trough or by blowing air on the profile. It can then be sawed or sheared to the desired length. In the case of a fiber, the fiber can be pulled out of the extrusion die spinnerets to the desired fiber diameter and crystallized for physical property enhancement.

In another aspect, a method of making an article is provided that comprises extruding fully compounded pellets of the copolyester composition, comprising the copolyester and flame retardants, to produce an injection molded article. In embodiments, the pellets can be dried at 150° F. to 190° F. (65.6° C. to 87.8° C.) for 4 to 6 hours to dry the pellets. The pellets can be fed to a reciprocating single screw extruder. The pellets are melted by the screw rotation and reciprocating action. Once the pellets reach the desired temperature, a gate is opened at the end of the extruder and the melted plastic is pumped by the screw into a heated mold to form an article of the desired shape. Once the mold is filled, a coolant is pumped through the mold to cool it and the melted plastic. Once the plastic has solidified, the mold is opened and the article is removed from the mold.

In another embodiment, the method can comprise mixing neat copolyester pellets with a concentrate of the flame retardant to form the copolyester composition and then extruding the copolyester composition to produce an injection molded article with or without short or long strand glass fiber reinforcement.

In another embodiment, a method for producing a product is provided that comprises mixing neat copolyester pellets with a flame retardant to form the copolyester composition and then calendering the copolyester composition to produce a film product. Calendering is a well-known process of forming a film or sheet through successive co-rotating parallel rollers. In embodiments for a calendering process, the pellets do not need to be pre-dried as the processing temperatures are low enough (350° F. to 400° F.; 177° C. to 204° C.) so degradation and hydrolysis of the polyester does not occur in a significant amount. The copolyester and flame retardant composition may be melted by using a high intensity mixer or extruder, including but not limited to, Buss Ko-kneader, a planetary gear extruder, Farrell continuous mixer, a twin screw extruder, or a Banbury® type mixer. The melt is then conveyed to the calender. A calender typically consists essentially of a system of three or more large diameter heated rollers which convert high viscosity plastic into a film or sheet. The flat sheet or film is conveyed in a continuous web to cool the sheet. It can then be trimmed to the desired width and then either rolled up into a roll or sheared or sawed into sheet form.

Although the copolyester composition may be prepared by mixing or blending a concentrate of flame retardants and copolyester, the copolyester composition may alternatively be prepared by blending the flame retardants directly with the copolyester, using any of the mixing or blending processed previously described for making the copolyester composition by blending the flame retardant concentrate and the copolyester. In embodiments, two or more flame retardants may be mixed or blended with the copolyester simultaneously or sequentially.

In embodiments, articles comprising any of the copolyester compositions (described herein) can be articles or components of articles configured for use or otherwise useful in any application where flame retardant properties are beneficial, for example in one or more of the following applications: medical device housings or components, housings for electronic devices or peripherals, personal electronic device components, television or monitor housings or components, power tool housings or components, power adapter housings or components, home automation device components, gaming device housings or components, building and construction materials and components, furnishing and home decoration components, wiring and connector housings or components, and automotive structural or decorative components.

This invention can be further illustrated by the following examples of certain embodiments thereof, although it will be understood that these examples are included merely for purposes of illustration and are not intended to limit the scope of the invention unless otherwise specifically indicated.

### EXAMPLES

The following abbreviations are used: J is Joules; J/m is Joules per meter; MPa is megapascal; FR is flame retardant; FRS is flame retardant synergist; DS is drip suppressant; CE is chain extender; FOT is flame out time; weight % is weight percent; TPA is terephthalic acid; TMCD is 2,2,4,4-tetramethylcyclobutane-1,3-diol and 1,4-CHDM is 1,4-cyclohexanedimethanol. PCTM is a glycol modified polyethylene cyclohexane dimethanol terephthalate. The materials used in testing are listed in Table 1.

TABLE 1
Materials used in testing

| Material | Type | Source/Grade Name |
|---|---|---|
| TX1000 | Resin | Eastman Tritan Copolyester TX1000 |
| NOFIA ® HM1100 | polyphosphonate FR | FRX Polymers (Europe), NV |
| Nofia HM9000 | polyphosphonate FR | FRX Polymers |
| Nofia HM7000 | polyphosphonate FR | FRX Polymers |
| Nofia AVG-4 | poly(phosphonate-co-carbonate) FR | FRX Polymers |
| BUDIT ® 315 | Melamine cyanurate FRS | Budenheim Ibérica S.L.U. |
| FA-5601 | Polytetrafluoroethylene (PTFE) DS | DAIKIN FLUOROCHEMICALS(CHINA) CO., LTD |
| Joncryl 4468 | Multifunctional CE | BASF |
| XiBond 920 | Multifunctional CE | Polyscope |
| Teflon 60 | PTFE DS | |
| Pyrochek 68PB | Brominated polystyrene FR | |
| Pyrobloc SAP-2 | Sodium antimonate FRS | |

Copolyester compositions were prepared by compounding a combination of materials via an extrusion process using a 26 mm twin screw extruder (Coperion ZSK 26 Mc18). All components were blended with the TX1000 base resin and fed from the mainstream into the extruder. The processing conditions used are shown in Table 2.

TABLE 2
Extrusion processing conditions

| Parameters | Unit | Value |
|---|---|---|
| Die | mm | 3.5 mm-4 hole |
| Zone 1 Temp | ° C. | 0 |
| Zone 2 Temp | ° C. | 180 |
| Zone 3 Temp | ° C. | 260 |
| Zone 4 Temp | ° C. | 260 |
| Zone 5 Temp | ° C. | 260 |
| Zone 6 Temp | ° C. | 260 |
| Zone 7 Temp | ° C. | 260 |
| Zone 8 Temp | ° C. | 260 |
| Zone 9 Temp | ° C. | 260 |
| Zone 10 Temp | ° C. | 260 |
| Zone 11 Temp | ° C. | 260 |
| Zone 12 Temp | ° C. | 260 |
| Die Temp | ° C. | 260 |
| Screw speed | rpm | 250 |
| Throughput | kg/hr | 14 |

Extruded strands were pelletized via a water bath/cutter or underwater pelletizer system, achieving an appropriate pellet size/shape for further processing.

The copolyester compositions were molded into parts for testing via an injection molding process using a FANUC100 injection machine. Barrel temperatures ranged from 260-280° C. with water-cooled mold temperatures ranging from 20-80° C. Test bars were molded at thicknesses of 1.5 mm and 2.0 mm (for UL 94 testing) and 3.2 mm (for other testing).

### Example 1

Examples 1.1 to 1.5 (and comparative examples 1.1 to 1.4) were prepared and molded into test parts (or plaques) as described above. The compositions of the test bars are listed below in Table 3. The UL 94 Vertical Burn and Notched Izod impact were measured for each example after conditioning the test bars for 40 hours at 23 C and 50% RH (normal) and also after conditioning the test bars for 168 hours at 70 C and then for 4 hours at 23 C and less than 20% RH (aging). UL 94 Vertical Burn testing results included FOT—Flame Out Time (seconds for 10 test bars), FD—Flame Drips (number of drips) and UL94 classification. The normal test results for vertical burn and notched izod impact are listed below in Table 4. The aging test results for vertical burn are listed below in Table 5. Additional test results for other properties are listed below in Table 6.

TABLE 3
Examples 1.1-1.5 and Comparative Examples 1.1 to 1.4 Compositions

| | Weight % | | | | | | | | |
|---|---|---|---|---|---|---|---|---|---|
| Component | Ex. 1.1 | Ex. 1.2 | Ex. 1.3 | Ex. 1.4 | Ex. 1.5 | C. 1.1 | C. 1.2 | C. 1.3 | C. 1.4 |
| TX1000 | 90 | 75 | 65 | 64.85 | 67.85 | 89.5 | 79.5 | 83.5 | 79.5 |
| HM1100 | 10 | | 10 | 10 | 8 | | | | |
| FA5601 | | | | 0.15 | 0.15 | | | | |
| Budit 315 | | 25 | 25 | 25 | 24 | 10 | 20 | | |
| Teflon 60 | | | | | | 0.5 | 0.5 | 0.5 | 0.5 |
| Pyrochek 68PB | | | | | | | | 12 | 15 |
| Pyrobloc SAP-2 | | | | | | | | 4 | 5 |

TABLE 4
Examples 1.1-1.5 and Comparative Examples 1.1 to 1.4 Normal Results

| Test/Results | Ex. 1.1 | Ex. 1.2 | Ex. 1.3 | Ex. 1.4 | Ex. 1.5 | C. 1.1 | C. 1.2 | C. 1.3 | C. 1.4 |
|---|---|---|---|---|---|---|---|---|---|
| Notched Izod | 1121 | 57.3 | 43 | 42.5 | 46.7 | 129 | 47 | 75 | 34 |
| (J/m) | | | | | | | | | |
| UL 94 @ | 40.0 | 0.0 | 15 | 0.0 | 0.0 | 850.0 | 50.0 | 32.0 | 6.0 |
| 1.5 mm(norm) | | | | | | | | | |
| FOT | | | | | | | | | |
| UL 94 @ | 10 | 8 | 2 | 0 | 0 | 5 | 5 | 0 | 0 |
| 1.5 mm(norm) | | | | | | | | | |
| FD | | | | | | | | | |
| UL 94 @ | V2 | V2 | V2 | V0 | V0 | Failed | V2 | V0 | V0 |
| 1.5 mm(norm) | | | | | | | | | |
| Classification | | | | | | | | | |
| UL 94 @ | | | | 0.0 | 15.7 | 38.0 | 52.0 | 34.0 | 2.0 |
| 2.0 mm(norm) | | | | | | | | | |
| FOT | | | | | | | | | |
| UL 94 @ | | | | 0 | 0 | 5 | 5 | 0 | 0 |
| 2.0 mm(norm) | | | | | | | | | |
| FD | | | | | | | | | |
| UL 94 @ | | | | V0 | V0 | V2 | V2 | V0 | V0 |
| 2.0 mm(norm) | | | | | | | | | |
| Classification | | | | | | | | | |

TABLE 5
Examples 1.1-1.5 and Comparative Examples 1.1 to 1.4 Aging Results

| | | | | | | | | | |
|---|---|---|---|---|---|---|---|---|---|
| Test/Results | Ex. 1.1 | Ex. 1.2 | Ex. 1.3 | Ex. 1.4 | Ex. 1.5 | C. 1.1 | C. 1.2 | C. 1.3 | C. 1.4 |

| | | | | | | |
|---|---|---|---|---|---|---|
| UL 94 @ | 0.0 | 7.7 | 972.0 | 60.0 | 81.0 | 4.0 |
| 1.5 mm(aged) | | | | | | |
| FOT | | | | | | |
| UL 94 @ | 0 | 0 | 5 | 5 | 0 | 0 |
| 1.5 mm(aged) | | | | | | |
| FD | | | | | | |
| UL 94 @ | V0 | V0 | Failed | V2 | V1 | V0 |
| 1.5 mm(aged) | | | | | | |
| Classification | | | | | | |
| UL 94 @ | 0.0 | 22.5 | 58.0 | 38.0 | 16.0 | 0.0 |
| 2.0 mm(aged) | | | | | | |
| FOT | | | | | | |
| UL 94 @ | 0 | 0 | 5 | 2 | 0 | 0 |
| 2.0 mm(aged) | | | | | | |
| FD | | | | | | |
| UL 94 @ | V0 | V0 | V2 | V2 | V0 | V0 |
| 2.0 mm(aged) | | | | | | |
| Classification | | | | | | |

TABLE 6
Examples 1.1-1.5 and Comp. Examples 1.1 to 1.4 Additional Results

| Experiment | Ex. 1.1 | Ex. 1.2 | Ex. 1.3 | Ex. 1.4 | Ex. 1.5 | C. 1.1 | C. 1.2 | C. 1.3 | C. 1.4 |
|---|---|---|---|---|---|---|---|---|---|
| Test/Results | | | | | | | | | |
| IV (dL/g) | 0.667 | 0.688 | 0.691 | 0.697 | 0.695 | 0.621 | 0.582 | 0.631 | 0.626 |
| Tg (° C.) | 107.9 | 108.3 | 109.5 | 109.3 | 108.7 | 106.0 | 106.0 | 109.0 | 109.0 |
| Density (g/cm3) | 1.188 | 1.270 | 1.276 | 1.271 | 1.277 | | | | |
| Flexural Yield | 76 | 69 | 76 | 76 | 76 | 64 | 64 | 66 | 67 |
| Strength (MPa) | | | | | | | | | |
| Flexural | 1907 | 2552 | 2876 | 2928 | 2854 | 1859 | 1863 | 1831 | 1884 |
| Modulus (MPa) | | | | | | | | | |
| Tensile Modulus | 1650 | 2330 | 2690 | 2700 | 2560 | 1891 | 2331 | 1828 | 1884 |
| (MPa) | | | | | | | | | |
| Tensile | 142 | 24 | 23 | 11 | 19 | 90 | 11 | 70 | 72 |
| Elongation (%) | | | | | | | | | |
| Un-notched | 2347 | 1203 | 795 | 609 | 713 | | | | |
| impact (J/m) | | | | | | | | | |

A review of Tables 3 and 4 reveals that EX.1 to EX.5 shows that the combination of HM1100, Budit 315 and FA5601 (PTFE) resulted in a positive effect for improving flame retardancy, where EX.4 and EX.5 demonstrated a robust UL 94 V0 rating. Whereas comparative examples C.1 and C.2, with only Budit 315 and PTFE was far from achieving a V0 rating. Regarding comparative examples C.3 and C.4, although a V0 rating was achieved, these formulations utilized brominated FR agents which are not favored for use in certain applications.

### Example 2

Examples 2.1 to 2.16 were prepared and molded into test parts (or plaques) as described above. UL 94 Vertical Burn tests were conducted (under normal conditions) and limiting oxygen index values were determined for each of these examples, and notched izod impact was measured for examples 2.13, 2.14 and 2.16. The compositions and normal UL test results, and notched izod impact values, are listed below in Tables 7 and 8. UL 94 Vertical Burn tests were also conducted (under aged conditions) for each of these examples. The aged UL test results are listed below in Tables 9 and 10.

The UL94 vertical burn tests were conducted for Example 2 as follows:

Normal testing was performed on test bars having a thickness of 3.2 mm, a width of 12.7 mm and a length of 152 mm. The test bars were conditioned for 40 hrs at 23 C and 50% RH prior to testing. For aged testing, the bars were conditioned for 168 hrs at 70 C and then for 40 hrs at 23 C and less than 20% RH. The following results were measured:
TAF—Total After Flame (t1+t2). TAF was measured according to UL 94 test procedures.
RIC—Reps Igniting Cotton (DIC). PIC was measured according to UL 94 test procedures.
UL94 classification.
FD—Total number of flame testing drips.
MFT—Maximum flame time (seconds). MFT was measured according to UL 94 test procedures.
TF/GT—Total Flame & Glow Time (seconds). TF/GT was measured according to UL 94 test procedures.
AFT (t1)—After Flame Time t1 was measured according to UL 94 test procedures.
AFT (t2)—After Flame Time t2 was measured according to UL 94 test procedures.
LOI—Limiting Oxygen Index value was measured by ASTM D2863.

TABLE 7
Examples 2.1-2.8 Compositions/UL Normal Testing Results

| | Weight % | | | | | | | |
|---|---|---|---|---|---|---|---|---|
| Component | Ex. 2.1 | Ex. 2.2 | Ex. 2.3 | Ex. 2.4 | Ex. 2.5 | Ex. 2.6 | Ex. 2.7 | Ex. 2.8 |
| TX1000 | 74.5 | 74.5 | 74.5 | 74.5 | 74.5 | 74.5 | 74.5 | 74.5 |
| HM1100 | 25 | | | | 25 | | | |
| HM9000 | | 25 | | | | 25 | | |
| HM7000 | | | 25 | | | | 25 | |
| AVG-4 | | | | 25 | | | | 25 |
| Joncryl 4468 | 0.5 | 0.5 | 0.5 | 0.5 | | | | |
| XiBond 920 | | | | | 0.5 | 0.5 | 0.5 | 0.5 |
| Test/Results | | | | | | | | |
| TAF | 10 | 10.1 | 10 | 32.5 | 11.4 | 26.7 | 23.4 | 93.2 |
| RIC | 5 | 5 | 5 | 5 | 5 | 5 | 4 | 5 |
| UL 94 | V2 | V2 | V2 | V2 | V2 | V2 | V2 | V2 |
| Classification | | | | | | | | |
| FD | 5 | 5 | 5 | 10 | 5 | 7 | 7 | 10 |
| MFT | 1 | 1 | 1 | 6 | 2 | 8 | 8 | 19 |
| TF/GT | 1 | 1 | 1 | 1 | 2 | 4 | 2 | 3 |
| AFT t1 | 1 | 1 | 1 | 5.5 | 1 | 3.7 | 3.3 | 16.9 |
| AFT t2 | 1 | 1 | 1 | 1 | 1.3 | 1.6 | 1.4 | 1.7 |
| LOI | 29.2 | 28.6 | 28.7 | 28.5 | 29.3 | 28.8 | 28.1 | 27.2 |

TABLE 8
Examples 2.9-2.16 Compositions/UL Normal Testing Results

| | Weight % | | | | | | | |
|---|---|---|---|---|---|---|---|---|
| Component | Ex. 2.9 | Ex. 2.10 | Ex. 2.11 | Ex. 2.12 | Ex. 2.13 | Ex. 2.14 | Ex. 2.15 | Ex. 2.16 |
| TX1000 | 49.5 | 49.5 | 49.5 | 49.5 | 49.5 | 49.5 | 49.5 | 49.5 |
| HM1100 | 50 | | | | 50 | | | |
| HM9000 | | 50 | | | | 50 | | |
| HM7000 | | | 50 | | | | 50 | |
| AVG-4 | | | | 50 | | | | 50 |
| Joncryl 4468 | 0.5 | 0.5 | 0.5 | 0.5 | | | | |
| XiBond 920 | | | | | 0.5 | 0.5 | 0.5 | 0.5 |
| Test/Results | | | | | | | | |
| Notched Izod | | | | | 26 | 34 | | 223 |
| (J/m) | | | | | | | | |
| TAF | 10.2 | 10 | 10 | 10.1 | 10 | 10 | 10 | 10 |
| RIC | 1 | 2 | 4 | 5 | 0 | 0 | 5 | 0 |
| UL 94 | V2 | V2 | V2 | V2 | V0 | V0 | V2 | V0 |
| Classification | | | | | | | | |
| FD | 5 | 5 | 5 | 5 | 5 | 5 | 5 | 4 |
| MFT | 1 | 1 | 1 | 1 | 1 | 1 | 1 | 1 |
| TF/GT | 1 | 1 | 1 | 1 | 1 | 1 | 1 | 1 |
| AFT t1 | 1 | 1 | 1 | 1 | 1 | 1 | 1 | 1 |
| AFT t2 | 1 | 1 | 1 | 1 | 1 | 1 | 1 | 1 |
| LOI | 30.1 | 30.6 | 31.6 | 30.8 | 29 | 29.5 | 30.3 | 28.8 |

TABLE 9
Examples 2.1-2.8 Compositions/UL Aged Testing Results

| Example | Ex. 2.1 | Ex. 2.2 | Ex. 2.3 | Ex. 2.4 | Ex. 2.5 | Ex. 2.6 | Ex. 2.7 | Ex. 2.8 |
|---|---|---|---|---|---|---|---|---|
| Test/Results | | | | | | | | |
| TAF | 10 | 10 | 10 | 33.8 | 16.8 | 22.1 | 40.5 | 73.3 |
| RIC | 5 | 5 | 5 | 5 | 5 | 5 | 5 | 3 |
| UL 94 | V2 | V2 | V2 | V2 | V2 | V2 | V2 | V2 |
| Classification | | | | | | | | |
| FD | 5 | 5 | 5 | 10 | 5 | 7 | 10 | 3 |
| MFT | 1 | 1 | 1 | 7 | 6 | 7 | 8 | 17 |
| TF/GT | 1 | 1 | 1 | 2 | 3 | 1 | 2 | 4 |
| AFT t1 | 1 | 1 | 1 | 5.3 | 1.9 | 3.4 | 6.7 | 11.3 |
| AFT t2 | 1 | 1 | 1 | 1.4 | 1.4 | 1 | 1.4 | 3.4 |

TABLE 10
Examples 2.9-2.16 Compositions/UL Aged Testing Results

| Example | Ex. 2.9 | Ex. 2.10 | Ex. 2.11 | Ex. 2.12 | Ex. 2.13 | Ex. 2.14 | Ex. 2.15 | Ex. 2.16 |
|---|---|---|---|---|---|---|---|---|
| Test/Results | | | | | | | | |
| TAF | 10.4 | 10 | 10 | 10 | 10 | 10 | 10 | 10.4 |
| RIC | 2 | 3 | 5 | 4 | 0 | 0 | 4 | 0 |
| UL 94 | V2 | V2 | V2 | V2 | V0 | V0 | V2 | V0 |
| Classification | | | | | | | | |
| FD | 5 | 5 | 5 | 5 | 4 | 5 | 5 | 2 |
| MFT | 1 | 1 | 1 | 1 | 1 | 1 | 1 | 1 |
| TF/GT | 1 | 1 | 1 | 1 | 1 | 1 | 1 | 1 |
| AFT t1 | 1 | 1 | 1 | 1 | 1 | 1 | 1 | 1 |
| AFT t2 | 1.1 | 1 | 1 | 1 | 1 | 1 | 1 | 1.1 |

A review of Tables 7-10 reveals that the formulations for Examples 2.13, 2.14 and 2.16 achieved a V0 rating at 3.2 mm thickness, under both normal and aged testing, and examples 2.1-2.3 and 2.9-2.16 all achieved an after-flame time of 1 to 2 seconds. This indicates that formulations with polyphosphonate and poly(phosphonate-co-carbonate) additives rapidly extinguished the flame with the HM1100, HM9000 and the AVG-4 being most effective, especially at the 50% loading level of the additives. The Limiting Oxygen Index for Tritan TX1000 is about 25%. The data from Tables 7 and 8 above show higher Limiting Oxygen Index values for all formulations, indicating that the compositions are more resistant to ignition.

Further, examples 2.13, 2.14 and 2.16 were tested for Notched Izod Impact Strength (ASTM D256). Tritan Copolyester typically has a Notched Izod Impact strength of about 1000 J/m. All the compositions showed a decrease in impact strength, but example 2.16, that contained Nofia AVG-4 and XiBond 920, retained a higher level of impact resistance.

The invention has been described in detail with reference to the embodiments disclosed herein, but it will be understood that variations and modifications can be affected within the spirit and scope of the invention.

1. A copolyester composition comprising:
(a) from about 50 to about 95 weight % of a copolyester, the copolyester comprising:
(i) a diacid component comprising
from 70 to 100 mole % residues of terephthalic acid,
from 0 to 30 mole % residues of a modifying aromatic diacid having from 8 to 12 carbon atoms, and
from 0 to 10 mole % residues of an aliphatic dicarboxylic acid; and
(ii) a glycol component comprising
from 45 to 95 mole % cyclohexanedimethanol (CHDM) residues,
from 5 to 65 mole % 2,2,4,4-tetramethylcyclobutane-1,3-diol (TMCD) residues, and
from 0 to 10 mole % of a modifying glycol having 2 to 20 carbon atoms;
wherein the inherent viscosity of the copolyester is from 0.5 to 1.2 dL/g as determined in 60/40 (wt/wt) phenol/tetrachloroethane at a concentration of 0.5 g/100 ml at 25° C., and
wherein the weight % is based on the weight of the copolyester, wherein the total mole % of the dicarboxylic acid component is 100 mole % and the total mole % of the glycol component is 100 mole %; and
(b) a flame retardant additive comprising a polyphosphonate compound, said flame retardant additive present in an amount from about 5 to about 55 weight %;
(c) at least one of the following: a flame retardant synergist, said synergist present in an amount from 10 to 40 wt %, and/or a multifuctional chain extender in an amount from about 0.1 to about 5 wt %; and
(d) from 0 to about 0.5 weight % of a drip suppressant additive;
wherein the copolyester composition has a UL 94 V-0 rating or better.

2. The copolyester composition according to claim 1, wherein the flame retardant additive is present in an amount from about 5 to about 20 wt %.

3. The copolyester composition according to claim 2, wherein the copolyester composition comprises a synergist in an amount from 10 to 40 wt %.

4. The copolyester composition according to claim 3, wherein the synergist comprises melamine cyanurate, aluminum phosphinate compounds, melamine polyphosphate (MPP), liquid phosphorous compounds (such as PhireGuard RDP and PhireGuard BDP), other organophosphorus compounds (e.g., compounds that contain phosphorus(V) with a double bond between P and N), or combinations thereof.

5. The copolyester composition according to claim 4, wherein the synergist comprises melamine cyanurate.

6. The copolyester composition according to claim 1, wherein the flame retardant additive is present in an amount from about 20 to about 55 wt %.

7. The copolyester composition according to claim 6, wherein the copolyester composition comprises a multifuctional chain extender in an amount from about 0.1 to about 2 wt %.

8. The copolyester composition according to claim 1, wherein the copolyester composition comprises a drip suppressant in an amount from 0.01 to 0.5 wt %.

9. The copolyester composition according to claim 1, wherein the copolyester composition further comprises: (e) from about 1 to about 10 wt % of an impact modifier component.

10. The copolyester composition according to claim 9, wherein the copolyester composition further comprises: (f) from about 0.1 to about 5 wt % of a compatibilizer.

11. The copolyester composition according to claim 1, wherein the glycol component comprises:
from 60 to 95 mole % cyclohexanedimethanol residues and
from 5 to 40 mole % of 2,2,4,4-tetramethylcyclobutane-1,3-diol residues.

12. The copolyester composition according to claim 11, wherein the glycol component comprises:
from 70 to 95 mole % cyclohexanedimethanol residues and
from 5 to 30, or 10 to 30, or 15 to 30, or 20 to 30, or 15 to 25 mole % of 2,2,4,4-tetramethylcyclobutane-1,3-diol residues.

13. The copolyester composition according to claim 11, wherein the glycol component comprises:
from 60 to 75 mole % cyclohexanedimethanol residues and
from 25 to 40, or 30 to 40 mole % of 2,2,4,4-tetramethylcyclobutane-1,3-diol residues.

14. The copolyester composition according to claim 1, wherein the inherent viscosity of the copolyester is from 0.55 to 0.85 dL/g.

15. The copolyester composition according to claim 1, wherein the flame retardant additive is present in an amount from 6 to 15 wt % of the copolyester composition.

16. The copolyester composition according to claim 1, wherein the copolyester composition comprises a flame retardant synergist additive chosen from Ammonium Polyphosphate, Melamine Phosphate, Melamine Pyrophosphate, Melamine Polyphosphate, Melamine poly(Zinc Phosphate), Melamine poly(Aluminum Phosphate), DOPO and DOPO derivatives, para-methyl phenyl phosphate, or combinations thereof.

17. The copolyester composition according to claim 7, wherein the copolyester composition further comprises a multifunctional epoxide chain extender chosen from a glycidyl methacrylate modified epoxide, a styrene and glycidyl methacrylate random copolymer, or a combination thereof.

18. The copolyester composition according to claim 1, wherein the copolyester composition has a notched Izod impact strength of 500 Joules/m or greater measured according to ASTM D256.

19. The copolyester composition according to claim 1, wherein the copolyester composition further comprises one or more additional additives chosen from colorants, dyes, mold release agents, additional flame retardants, plasticizers, processing aids, rheology modifiers, nucleating agents, antioxidants, light stabilizers, fillers, and reinforcing materials.

20. An article comprising a copolyester composition according to claim 1, wherein the article is in the form of a film, sheet, molded part, or profile, and wherein the article is chosen from medical device housings or components, housings for electronic devices or peripherals, personal electronic device components, television or monitor housings or components, power tool housings or components, power adapter housings or components, home automation device components, gaming device housings or components, building and construction materials and components, furnishing and home decoration components, wiring and connector housings or components, and automotive structural or decorative components.
